(19) United States
(12) Patent Application Publication
(10) Pub. No.: US 2025/0258933 A1
(43) Pub. Date: Aug. 14, 2025

(54) PERFORMING COMPUTE FUNCTIONS IN SECURE COMPUTE NODES

(71) Applicant: International Business Machines Corporation, Armonk, NY (US)

(72) Inventor: Daniel Waddington, Morgan Hill, CA (US)

(21) Appl. No.: 18/441,944

(22) Filed: Feb. 14, 2024

(51) Int. Cl. G06F 21/60; G06F 21/53

(52) U.S. Cl. CPC G06F 21/602; G06F 21/53

(57) ABSTRACT

A computer-implemented method (CIM), according to one approach, includes causing a first compute function to be performed on a first secure compute node that is configured to retrieve data from a storage system. Performing the first compute function includes retrieving encrypted first data from the storage system, causing a first encryption key to be used to decrypt at least some of the encrypted first data, and running predetermined code on the decrypted data. The method further includes providing a first client site with first data that includes results of running the predetermined code on the decrypted data. A computer program product (CPP), according to another embodiment, includes a set of one or more computer-readable storage media, and program instructions, collectively stored in the set of one or more storage media, for causing a processor set to perform the foregoing method.

### BACKGROUND

The present invention relates to data storage, and more specifically, this invention relates to data storage security.

Networks connect different devices in order for resources of the devices to be shared with one another. In some data storage networks, client devices (which may be a known type of user device with computation resources) upload data to a storage system, e.g., such as cloud storage. This way, rather than having to store all data locally, the client devices are able to borrow storage resources of the storage system, and thereby selectively access the data from the storage system.

### SUMMARY

A computer-implemented method (CIM), according to one approach, includes causing a first compute function to be performed on a first secure compute node that is configured to retrieve data from a storage system. Performing the first compute function includes retrieving encrypted first data from the storage system, causing a first encryption key to be used to decrypt at least some of the encrypted first data, and running predetermined code on the decrypted data. The method further includes providing a first client site with first data that includes results of running the predetermined code on the decrypted data.

A computer program product (CPP), according to another embodiment, includes a set of one or more computer-readable storage media, and program instructions, collectively stored in the set of one or more storage media, for causing a processor set to perform the foregoing method.

A computer system (CS), according to another embodiment, includes a processor set, a set of one or more computer-readable storage media, and program instructions, collectively stored in the set of one or more storage media, for causing the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3A is a flowchart of a method, in accordance with one embodiment of the present invention.

FIG. 3B is a flowchart of sub-operations of an operation of FIG. 3A, in accordance with one embodiment of the present invention.

FIG. 4 is an environment, in accordance with one embodiment of the present invention.

FIG. 5 is an environment, in accordance with one embodiment of the present invention.

FIG. 6 is an environment, in accordance with one embodiment of the present invention.

FIG. 7 is an environment, in accordance with one embodiment of the present invention.

FIG. 8 illustrates a relationship, in accordance with one embodiment of the present invention.

FIGS. 9A-9E illustrate environments, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for performing compute functions in secure compute nodes.

In one general embodiment, a CIM includes causing a first compute function to be performed on a first secure compute node that is configured to retrieve data from a storage system. Performing the first compute function includes retrieving encrypted first data from the storage system, causing a first encryption key to be used to decrypt at least some of the encrypted first data, and running predetermined code on the decrypted data. The method further includes providing a first client site with first data that includes results of running the predetermined code on the decrypted data.

In another general embodiment, a CPP includes a set of one or more computer-readable storage media, and program instructions, collectively stored in the set of one or more storage media, for causing a processor set to perform the foregoing method.

In another general embodiment, a CS includes a processor set, a set of one or more computer-readable storage media, and program instructions, collectively stored in the set of one or more storage media, for causing the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as compute function code of block 150 for performing compute functions in secure compute nodes. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

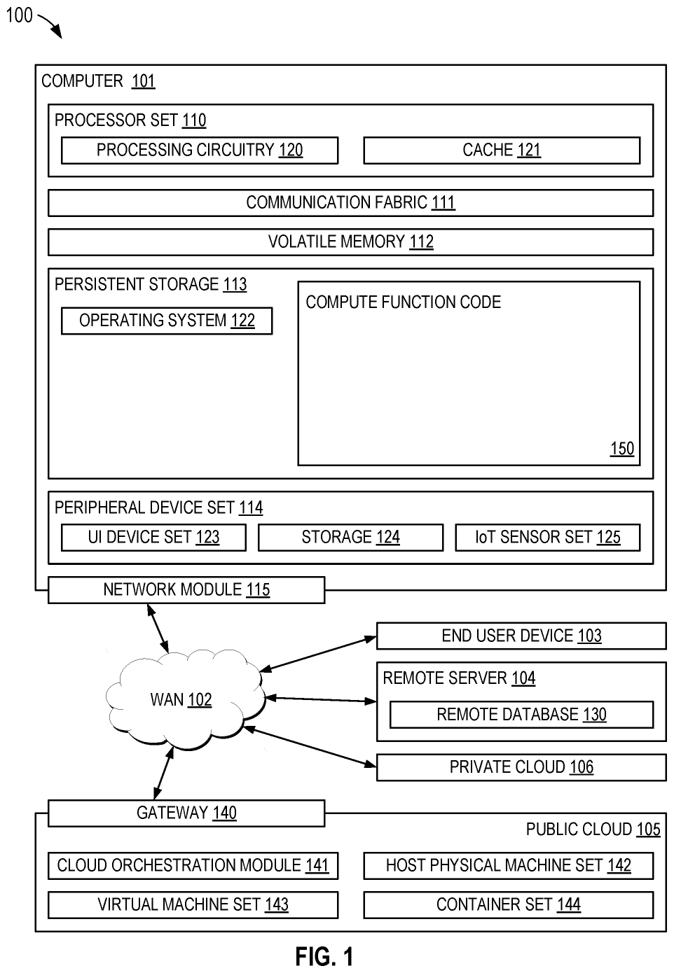

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

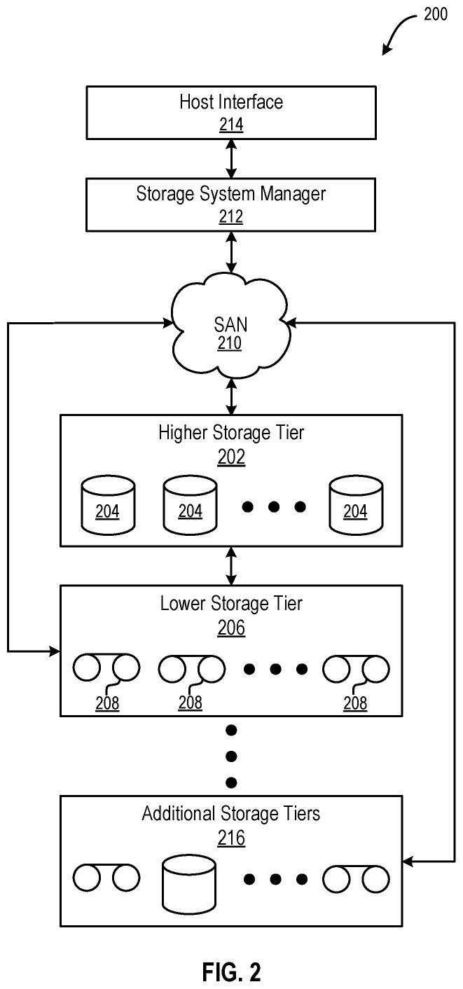

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, networks connect different devices in order for resources of the devices to be shared with one another. In some data storage networks, client devices (which may be a known type of user device with computation resources) upload data to a storage system, e.g., such as cloud storage. This way, rather than having to store all data locally, the client devices are able to borrow storage resources of the storage system, and thereby selectively access the data from the storage system.

In some use cases, a client device acts as a compute node, e.g., includes computational resources for generating and/or processing data, and relies on storage resources of a storage system for storing the data and/or providing on-demand access to the data. In some alternative use cases, compute operations are performed on data in the storage system. However, the performance of computations operations on the storage system of a network is problematic for a number of reasons. For example, a single storage system node likely does not have all the “pieces” of data required for a given computation as the data may be distributed across multiple nodes. This means that to obtain the contents of a single file corresponding to a database file, data must be read from multiple nodes into a single point of operation. This results in relatively more data movement (increase in overhead) and an incurred capacity in order to stitch together the data prior to the data being operated on. The performance of computation operations on the storage system of a network is furthermore problematic with respect to security concerns. This is, at least in part, because storage systems, especially those in the cloud, hold data from multiple tenants (end users or client devices). More specifically, a security issue exists given that infiltration of a storage node could lead to data from multiple clients in the clear being exfiltrated (e.g., through side-channel attacks).

In sharp contrast to the deficiencies described above, the techniques of embodiments and approaches described herein enable an architecture for secure near-storage compute while mitigating the security and latency issues described above.

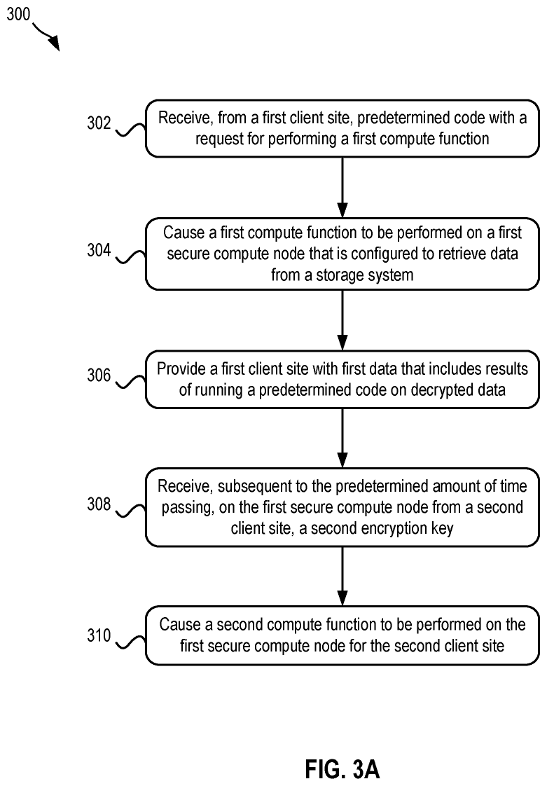

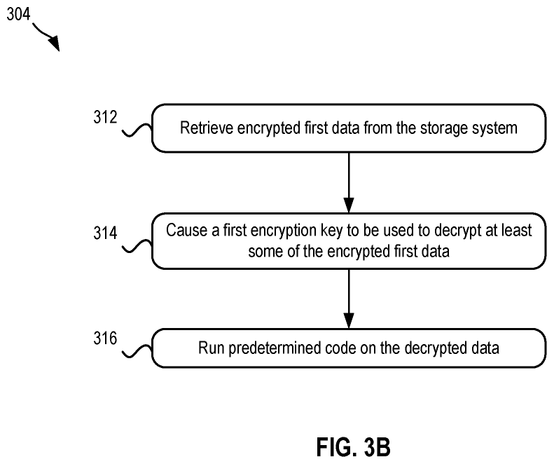

Now referring to FIG. 3A, a flowchart of a method 300 is shown according to one embodiment. The method 300 may be performed in accordance with the present invention in any of the environments depicted in FIGS. 1-9E, among others, in various embodiments. Of course, more or fewer operations than those specifically described in FIG. 3A may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 may, in some approaches, be performed in a distributed computing environment in which a client application of a client device is configured to access wide-area or geo-distributed data that is stored in one or more storage systems. The client device may be a communication and/or computing device of a type that would become apparent to one of ordinary skill in the art after reading the descriptions herein, e.g., a desktop computer, a laptop computer, a tablet computer, a smart phone, etc. Furthermore, the client application may be a business intelligence and/or real-time analytic based application of a type that would become apparent to one of ordinary skill in the art after reading the descriptions herein. Each of the storage systems may store data from one or more client devices, but as will be described below, the client data of each of the client devices is protected and secure from being accessed by other client devices and/or other unauthorized devices. The storage systems may each include one or more storage components, e.g., a server, storage hardware, a storage drive, etc.

The distributed computing environment furthermore preferably includes one or more secure compute nodes that may be configured to interact with the client device and/or storage systems, but that is secure from being accessed by the client device and storage systems, e.g., the client device and the storage systems cannot observe the details of computations performed in one or more of the secure compute nodes. In some other approaches, the client device may be able to securely access the secure compute node(s) implicitly. It should be noted that, in preferred approaches, method 300 is performed by one of such secure compute nodes. The compute nodes are “secure” in that computations performed within the compute nodes are not observable by any other portions of the environment. For example, the storage system preferably does not have access to the computations performed within the secure compute nodes and furthermore results of the computations performed unless one or more of the secure compute nodes share the results by upload the results to the storage system. Further configuration details that ensure that the secure compute nodes are secure from the rest of the environment are described elsewhere below, e.g., see descriptions of encryption keys elsewhere herein.

In some approaches, one or more of the secure compute nodes described herein are nodes that are separate physical components than components of the storage systems, e.g., separate component(s) that are configured to selectively communicate with the storage system and one or more client sites. In some other approaches, a secure compute node may be a virtual machine that is made up of a dedicated portion of the storage system, but that is protected by a security measure, e.g., firewall, of a type that would become apparent to one of ordinary skill in the art after reading the descriptions herein. For example, in one or more of such approaches, the secure compute node may be a secure container that stores encryption keys, has dedicated computational resources, and/or is configured to be wiped of contents stored therein.

Operation 302 includes receiving, at a first secure compute node from a first client site, a request for performing a first compute function, e.g., a request for the first client site to offload computational operations to another site. In some preferred approaches, the compute function is a function that incorporates access to data that is stored on one or more of the storage systems of an environment that includes the first client site. Accordingly, in some approaches, the request is received by a component that is performing method 300, is configured to communicate with the first client site, and that is configured to retrieve data from the storage system(s).

The request is, in some approaches, received with predetermined code that when executed, performs the first compute function. For example, an execution of the predetermined code may use at least some data stored on the storage system(s) to generate results, e.g., where the results are an output of a compute engine that executes and performs the first compute function. In some other approaches, the predetermined code is received separately from the request, e.g., such as in response to a component performing method 300 issuing a query to the first client site for the predetermined code. In some other approaches, the first client site may already have access to the predetermined code, e.g., the code may be securely stored in an encrypted format of a type that would become apparent to one of ordinary skill in the art after reading the descriptions herein.

The first compute function is caused, e.g., instructed, to be performed on the first secure compute node, e.g., see operation 304. The first secure compute node is configured to retrieve data from at least one of the storage systems of the environment, e.g., where data that is to be used for performing (e.g., executing) the first compute function is stored. In some approaches, at least some of this data was previously generated by the first client site. This data may additionally and/or alternatively include data that was previously generated by performing one or more other compute functions, e.g., a second compute function, a third compute function, etc., for the first client site. As mentioned elsewhere above, the first secure compute node and the storage system may communicate with one another via a network (such as a wide-area network) and exist in the same environment.

In some approaches, the first compute function is caused to be performed on the first secure compute node in use cases in which the first secure compute node is relatively local to the storage system, e.g., a secure and dedicated portion of the storage system or a system connected via a short-distance, high-bandwidth communications channel. This way, relatively less data is transmitted within the environment than would otherwise occur if the first client site pulled the data from the storage system to perform the first compute function. In some other approaches, the first compute function is caused to be performed on the first secure compute node in use cases in which the first secure compute node has a relatively faster connection to the storage system. Examples of such a configuration include the first secure compute node being a data processing unit (DPU) that is a secure and isolated execution environment connected to the storage system via a high-performance Ethernet channel. In another approach, the first secure compute node may be a DPU that is a secure and isolated execution environment connected to the storage system via a peripheral component interconnect (PCI) express. Based on these configurations, by causing the first compute function to be performed on the first secure compute node rather than the first client site, relatively less data may be transmitted over relatively slower portions of the environment. For example, the connection between the first client site and the storage system and/or the first secure compute node may, in some approaches, rely on a SAN and therefore have relatively more data transmission latency and throughput than otherwise experienced by data transmission between the storage system and the first secure compute node. Techniques for performing the first compute function are described below.

Looking to FIG. 3B, exemplary sub-operations of performing the first compute function are illustrated in accordance with one embodiment, one or more of which may be used to perform operation 304 of FIG. 3A. However, it should be noted that the sub-operations of FIG. 3B are illustrated in accordance with one embodiment which is in no way intended to limit the invention.

Sub-operation 312 includes retrieving encrypted first data from the storage system. In some preferred approaches, method 300 is performed by the first secure compute component, and therefore the retrieving encrypted first data from the storage system may include the first secure compute component issuing a request for the encrypted first data to the storage system. In some other approaches, in which the first secure compute component is a dedicated portion of the storage system, e.g., a secure virtual machine of the storage system, retrieving encrypted first data from the storage system may include accessing data storage drives of the storage system and performing a read operation. In one illustrative approach, the first secure compute node may be a virtual machine that is configured to retrieve data from the storage system via an Ethernet switch, e.g., a Gigabit Ethernet switch.

In preferred approaches, the storage system does not have access to a first encryption key (that may be used to decrypt the encrypted first data) while the first secure compute node does have access to the first encryption key. The first encryption key may be provided securely (e.g., via a secure key exchange protocol) to the first secure compute node by the first client site and furthermore, in some approaches, may have previously generated the first encryption key during encryption of the first data.

The sub-operations of FIG. 3B furthermore include causing a first encryption key to be used to decrypt at least some of the encrypted first data, e.g., see sub-operation 314. In some use cases, one or more portions of the first secure compute node may not include sufficient resources for performance of a decryption of the first encryption key and/or performance of the first compute function. Accordingly, in optional configurations of the environment, the first secure compute node may be attached to an accelerator component that the first secure compute node uses to perform predetermined operator functions. For example, the predetermined operator functions may include the decrypting of at least some of the encrypted first data and/or decompression of the first data after being retrieved from the storage system.

Sub-operation 316 includes running the predetermined code on the decrypted data. A portion of the encrypted first data may, in some approaches, not be decrypted during performance of the first compute function. In other words, in one or more of such approaches, in order to preserve processing resources, only portions of the encrypted data that are determined to need to be in a decrypted state are ensured to be decrypted using the encryption key. Performance of the first compute function may, in some approaches, include deleting a portion of the encrypted first data, e.g., a portion of the first data that is intentionally not decrypted. In other words, any portion of the encrypted first data that is going to be deleted may be not decrypted in order to preserve processing resources and increase security. In contrast, in some other approaches, the portions of the first data that are scheduled for deletion may need to be decrypted in order to be identified.

Portions of the first data may, in some other approaches, additionally and/or alternatively not be decrypted by the first secure compute node in response to a determination that the portions of the first data are not used to perform the first compute function. In other words, the portions of the first data may not be used to perform the first compute function but nonetheless included in a packet of results of performing the first compute function that are returned to the first client site. Accordingly, method 300 optionally includes adding the portion of the encrypted first data into the first data provided to the first client site, e.g., portions of unencrypted data are tacked onto the unencrypted results of performance of the first compute function that are provided to the first client site. In some approaches, the encryption of the data in the storage system, e.g., the retrieved data and/or the results saved to the storage system, may be different from the encryption of generated results. For example, in order to further complexities associated with the encryptions, in one or more of such approaches, a different encryption key (than the encryption key that was used to encrypt data retrieved from and/or stored to the storage system) may be used to encrypt the results that are provided to the first client site.

With reference again to FIG. 3A, operation 306 includes providing a first client site with first data that includes results of running the predetermined code on the decrypted data. Running the predetermined code on the decrypted data, in some approaches, transforms the decrypted data. For example, running the predetermined code may generate new data using the decrypted data. A sum size of the predetermined code and the results (which may include new data) of running the predetermined code on the decrypted data is preferably relatively smaller than the size of the encrypted first data retrieved from the storage system to perform the first compute functions. In other words, as a result of performing method 300 (as opposed to the first client site instead retrieving the encrypted first data from the storage system in order for the first client site to perform the compute function) relatively less transmission bandwidth is consumed between the client site and the storage system. This thereby reduces the amount of data that is transmitted across a network (such as a wide-area network) of the environment that includes the first secure compute node and the storage system, and thereby improves functionalities of computer devices within the environment.

The first secure compute node is, in some approaches, configured according to a predetermined time-multiplexed scheme. For example, in one or more of such approaches, the predetermined time-multiplexed scheme configuration may be based on the first secure compute node holding encryption key(s) for a predetermined amount of time. This predetermined amount of time may allow the first secure compute node to retain keys at different times for different client sites. More specifically, the predetermined time-multiplexed scheme configuration may ensure that different encryption keys that are associated with and/or received from different client sites are intentionally never stored in the first secure compute node at the same time. This way, the first secure compute node is ensured to not mix decrypted data associated with two or more different client sites in the results returned to the same client site.

As a part of the predetermined time-multiplexed scheme configuration, the first secure compute node may be configured to wipe a history of execution of compute functions (including a memory state) on the first secure compute node in response to a determination that the predetermined amount of time has passed. Techniques that would become apparent to one of ordinary skill in the art after reading the descriptions herein may be used. For example, in some approaches, the wiping includes verifiably deleting the encryption key(s), e.g., such as where a receipt that details the encryption key(s) being deleted is generated during the wiping. Results of the performance of compute functions may be uploaded to the storage system with such a receipt, in some approaches. The results of the performance of compute functions may also be verifiably deleted in some approaches. However, in some approaches, method 300 may include encrypting results of performance of the first secure compute node and outputting the encrypted results to the first client site and/or the storage system before verifiably deleting such results.

The predetermined time-multiplexed scheme configuration allows the first secure compute node to be used for performing compute functions for a plurality of different client sites, e.g., sequentially performing the different compute functions over time. For example, in some approaches, method 300 includes receiving, subsequent to the predetermined amount of time passing, on the first secure compute node from a second client site, a second encryption key, e.g., see operation 308. Operation 310 includes causing a second compute function to be performed on the first secure compute node for the second client site, e.g., using similar techniques to those described elsewhere above for causing the first compute function to be performed on the first secure compute node. It should be noted that the storage system preferably does not have access to the second encryption key in order to ensure that the second compute and encrypted data of the storage system that is retrieved to perform the second compute function is kept private, e.g., not able to be snooped by an unauthorized device.

In contrast to the approaches described above with respect to predetermined time-multiplexed scheme configurations, in some other approaches, the environment may additionally and/or alternatively include a plurality of secure compute nodes that may be used to perform a plurality of compute functions for one or more client sites. For example, in one or more of such approaches, method 300 includes causing a second compute function to be performed on a second secure compute node that is configured to retrieve data from the storage system. The first compute function and the second compute functions may be concurrently performed in some approaches, while in some other approaches, at least a portion of the first compute function and the second compute functions are performed at different times. A second client site may be provided with second data that results from performing the second compute function, and results of performing the second compute functions and/or the second encryption key used to perform the second compute function may be wiped from the second secure compute node, e.g., in response to a predetermined amount of time passing, in response to a determination that the second compute function has been fully performed, in response to results of performing the second compute function being delivered to the second client site, in response to results of performing the second compute function being encrypted and/or stored in the storage system, etc.

In addition to reducing the amount of data that is transmitted from storage systems to client sites, the techniques described above mitigate security issues in the technical field of data storage. In order to do this, encryption keys are only provided to the secure compute node(s). It should be noted that, in some approaches in which the storage system of the environment is a cloud-based storage system, the cloud-based storage system may store data from multiple tenants (clients). Accordingly, having the storage system perform such compute functions for the client sites otherwise creates security issues, as the system would need to hold all the encryption keys for all the data that is received to perform these compute functions. The storage system having access to all of the encryption keys presents a serious security issue given that the infiltration of a storage node could lead to data from multiple clients in the clear being exfiltrated, e.g., through side-channel attacks. Accordingly, the techniques and infrastructure described herein present an architecture for secure near-storage compute that addresses the previously discussed security limitations while offering novel techniques for efficient computational storage.

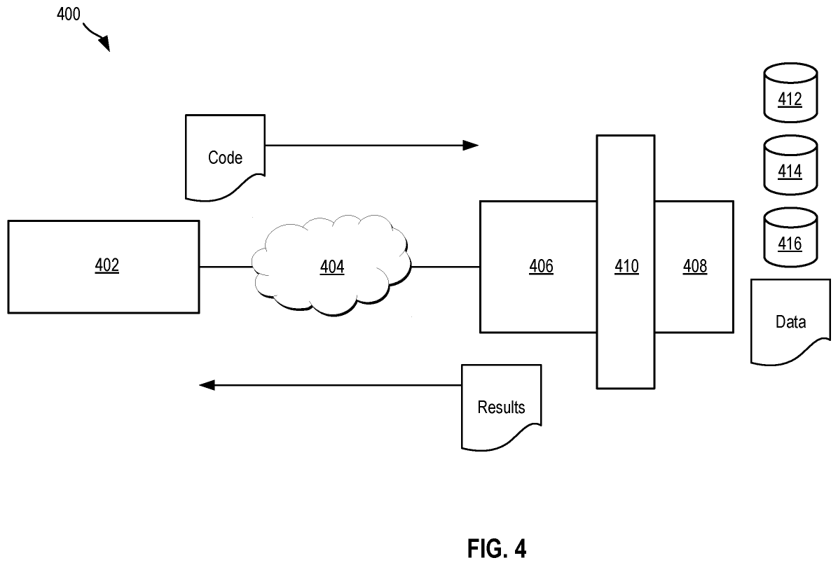

FIG. 4 depicts an environment 400, in accordance with one embodiment. As an option, the present environment 400 may be implemented in conjunction with features from any other embodiment listed herein, such as those described with reference to the other FIGS. Of course, however, such environment 400 and others presented herein may be used in various applications and/or in permutations which may or may not be specifically described in the illustrative embodiments listed herein. Further, the environment 400 presented herein may be used in any desired environment.

The environment 400 includes a first client site 402 that is connected to, e.g., in communication with over internet 404, a first secure compute node 406 and a storage system 408. The first secure compute node 406 may be secure based on a firewall 410 being in put in place that segregates the first secure compute node from the storage system. In some approaches, the first client site may be associated with a client application that requires access to wide-area or geo-distributed data that is stored in the storage system, e.g., see data which may be stored on one or more storage components 412, 414 and 416 of the storage system. Illustrative client applications of this nature may, in some approaches, include business intelligence and real-time analytics.

Techniques described herein may be used to allow compute near-storage but firewall the storage system from the secure compute node, thus enabling the storage system to be assumed untrusted. The compute capability may be co-located with the storage system and may be assumed to have a high-bandwidth network or data bus connection. Trust is partitioned in that one or more client sites may establish a trust agreement only with the remote secure compute node that performs a compute operation on a client's corresponding data. In some approaches, the compute operation includes retrieving encrypted first data from the storage system, e.g., see data, and causing a first encryption key to be used to decrypt at least some of the encrypted first data. In some approaches, the first encryption key may be received by the secure compute node from the client node, along with code which may be used to perform the compute function, e.g., see code. This code may be run on the decrypted data, and data that includes results of running the code on the decrypted data may be provided to the client site, e.g., see results.

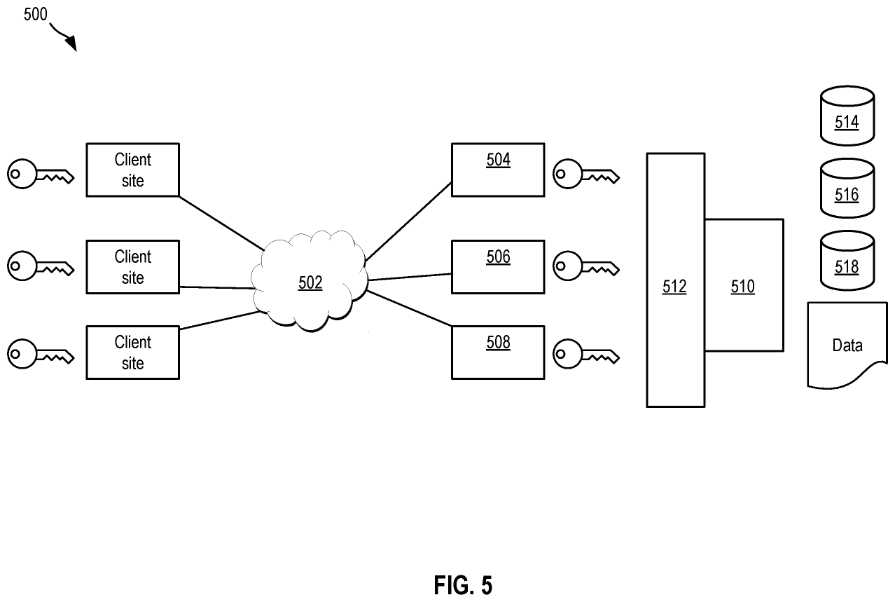

FIG. 5 depicts an environment 500, in accordance with one embodiment. As an option, the present environment 500 may be implemented in conjunction with features from any other embodiment listed herein, such as those described with reference to the other FIGS. Of course, however, such environment 500 and others presented herein may be used in various applications and/or in permutations which may or may not be specifically described in the illustrative embodiments listed herein. Further, the environment 500 presented herein may be used in any desired environment.

The environment 500 includes a plurality of client sites that are in communication with, e.g., via internet 502, secure client nodes 504, 506 and 508, and a storage system 510 that is firewalled from the secure client nodes, e.g., see firewall 512. It may be noted that none of the secure compute nodes have access to encryption keys from multiple clients, i.e., each of the secure compute nodes only have access to one encryption key at a given time for decrypting data to perform compute functions. The storage system stores encrypted data, e.g., see data, which may be stored on one or more storage components 514, 516 and 518 of the storage system.

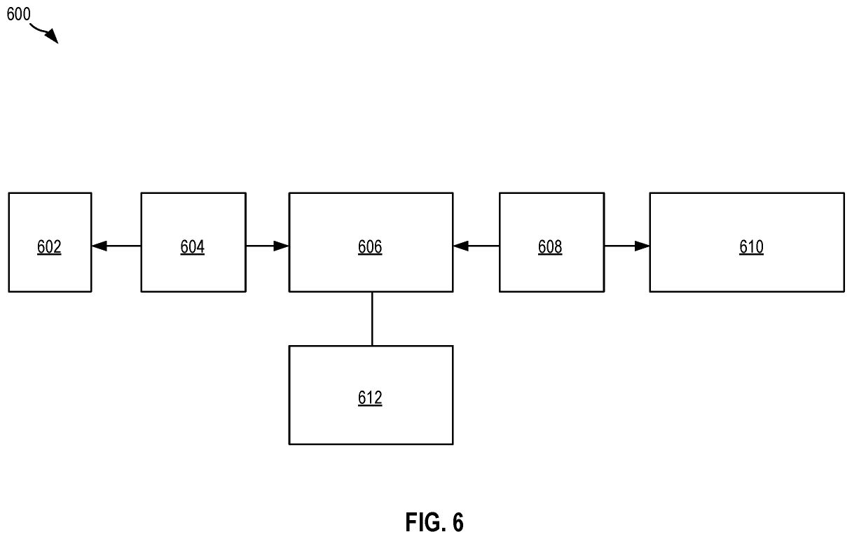

FIG. 6 depicts an environment 600, in accordance with one embodiment. As an option, the present environment 600 may be implemented in conjunction with features from any other embodiment listed herein, such as those described with reference to the other FIGS. Of course, however, such environment 600 and others presented herein may be used in various applications and/or in permutations which may or may not be specifically described in the illustrative embodiments listed herein. Further, the environment 600 presented herein may be used in any desired environment.

The environment 600 is a relatively high-level separation architecture in which the operations of techniques described herein, e.g., method 300, may be performed. The environment 600 includes a client site 602 that is in communication with a secure compute node 606 via a relatively slower network 604. In some approaches, the secure compute node 606 is a dedicated computer where compute functions of the dedicated computer are firewalled from the storage system and other portions of the environment during performance of compute functions. The secure compute node 606 is configured to selectively pull and/or upload data to a storage system 610 via a relatively fast and secure network 608. The secure compute node may, in some approaches, be implemented in a variety of ways providing that the secure compute node can be sufficiently isolated from the storage system and the secure compute node can access data in the storage system over a relatively high-performance channel (the relatively fast and secure network 608), e.g., multiple GB/s.

In this basic “separation architecture” the client site hosts some application that wants to perform a compute on data of the storage system, e.g., database, business intelligence and analytics, etc. The relatively slower network 604 may be geo-distributed and therefore, the secure compute node 606 establishes a trust relationship with the client site 602. For context, this means that the client site may securely exchange the data encryption key with the secure compute node. The secure compute node is also configured to perform a compute function (in some approaches by instructing an optional side accelerator 612) that includes retrieving encrypted data from the storage system, decrypting the data using the encryption key, performing one or more operations on the data, e.g., filter, canonicalization, anonymization, transformation, etc., and then re-encrypting the data (with the same or more securely with a different key) and sending the results to the client site. The key point of operation within the environment 600 is that the secure compute node performs data reduction. In other words, the volume of data retrieved from the storage system and transmitted across the relatively fast and secure network 608 is orders of magnitude larger than the volume of data transmitted across the relatively slow network 604. For example, the data retrieved from the storage system may, in some approaches, include a database table (or some data-skipping segments), and running predetermined code on the data may include performing a filter on one or more fields of the table. The result is the filtered data, and thereby relatively less data is transmitted over the relatively slow network than would otherwise be transmitted if the client site were to perform the compute function.

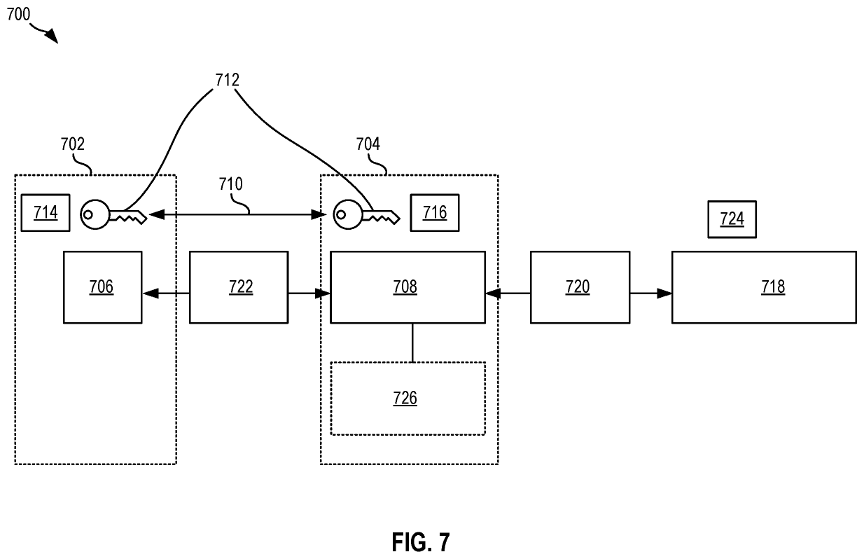

FIG. 7 depicts an environment 700, in accordance with one embodiment. As an option, the present environment 700 may be implemented in conjunction with features from any other embodiment listed herein, such as those described with reference to the other FIGS. Of course, however, such environment 700 and others presented herein may be used in various applications and/or in permutations which may or may not be specifically described in the illustrative embodiments listed herein. Further, the environment 700 presented herein may be used in any desired environment.

Within environment 700, a key feature is the separation of data storage from data compute and the establishment of minimal attack surfaces “around” the data that is temporarily decrypted to enable operations to be performed on it. In order to enable this feature, security boundaries 702 and 704 are established for the architecture. A client site 706 establishes trust with a secure compute node 708, e.g., an enclave, through an encryption key 712 exchange process 710, e.g., which may include a Diffie-Hellman key exchange or any other type of key exchange that would become apparent to one of ordinary skill in the art after reading the descriptions herein. Sensitive data 714 and 716 is decrypted for operations only at the client site and the secure compute node. The exchanged cryptographic encryption key 712 is used both to decrypt the data 724 received from a storage system 718 via an insecure network 720, as well as re-encrypting the data for returning results back to the client site, e.g., see network 722 which may be used to exchange the keys, exchange encrypted data, receive code used to perform compute functions on the secure compute node, etc. In some approaches, different keys are used for the two roles and multiple keys are exchanged during the exchange process 710. Furthermore, the secure compute node may, in some approaches, rely on an optional side accelerator 726 to perform at least some of a compute function. For example, the secure compute node may optionally leverage hardware accelerators to perform operator functions such as regular expression matching, (de-)encryption, and (de-)compression, in some approaches.

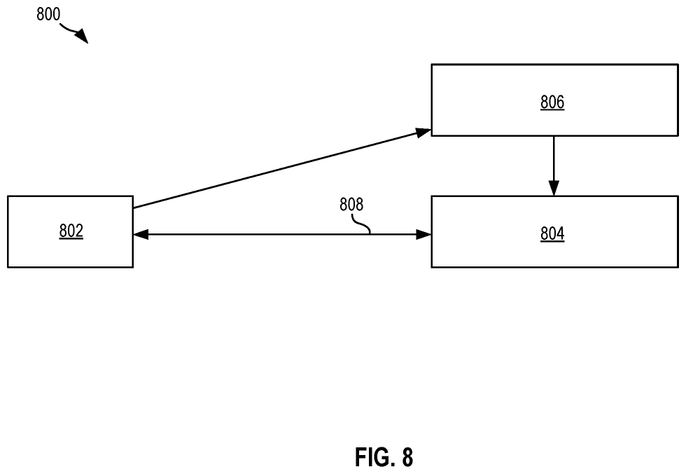

FIG. 8 depicts a relationship 800, in accordance with one embodiment. As an option, the present relationship 800 may be implemented in conjunction with features from any other embodiment listed herein, such as those described with reference to the other FIGS. Of course, however, such relationship 800 and others presented herein may be used in various applications and/or in permutations which may or may not be specifically described in the illustrative embodiments listed herein. Further, the relationship 800 presented herein may be used in any desired environment.

The relationship 800 is established between a client site 802 and one or more ephemeral secure compute nodes, e.g., note that a single secure compute node 804 is shown in FIG. 8, although the relationship may be established between the client site and a plurality of secure compute nodes in some other approaches).

Secure compute nodes may be configured to be time-multiplexed, in some approaches, but secure compute nodes are preferably not configured to be shared by different client sites at the same time (they implicitly do not support multi-tenancy). Techniques described in some approaches herein use a scheme whereby the hardware and software for secure compute nodes may be optionally dynamically allocated by some management entity, e.g., see resource manager 806. For example, when a client site wishes to allocate a secure node for a given set of operations or duration, a trusted manager may, in some approaches, be contacted to make a request for the resource, e.g., which may be received by a component (such as the secure compute node) that performs the compute function. Once the resource has been allocated, the client site must establish trust with the secure compute node. This includes attestation 808 of the hardware and software through secure hardware, e.g., a trusted platform module (TPM), and a secure software boot, e.g., confidential virtual machine boots, in some approaches. This way, the use of ephemeral secure node/enclaves that are dynamically instantiated and have hardware and software attested by a client to ensure secure execution of near-storage operations is enabled. Furthermore, the use of time-multiplexed, single-tenant push-down compute nodes improves security and reduces attack proliferation of the environments described herein.

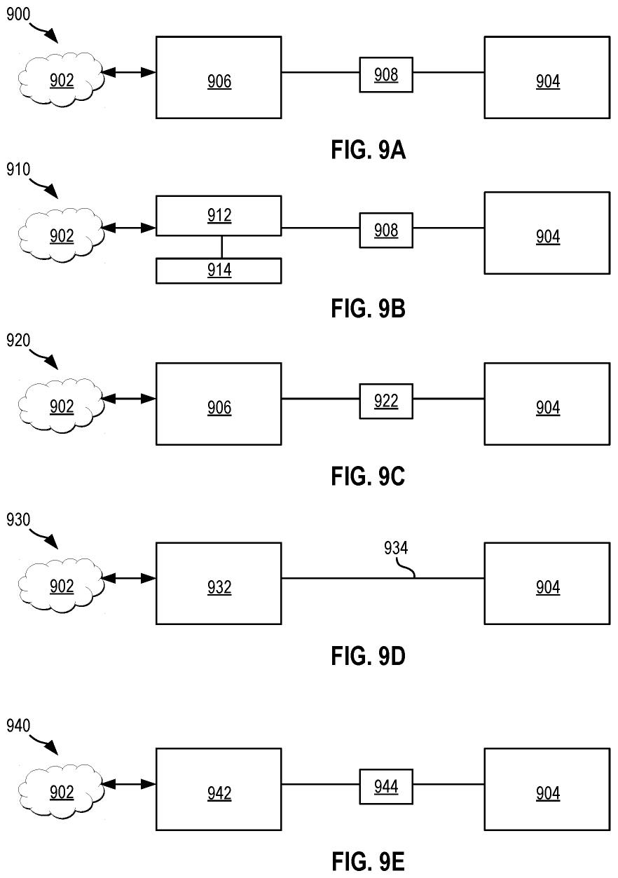

FIGS. 9A-9E depict environments 900, 910, 920, 930 and 940, in accordance with several embodiments. As an option, the present environments 900, 910, 920, 930 and 940 may be implemented in conjunction with features from any other embodiment listed herein, such as those described with reference to the other FIGS. Of course, however, such environments 900, 910, 920, 930 and 940 and others presented herein may be used in various applications and/or in permutations which may or may not be specifically described in the illustrative embodiments listed herein. Further, the environments 900, 910, 920, 930 and 940 presented herein may be used in any desired environment.

It may be prefaced that some of the environments may include similar components and therefore common numbering may be shared between two or more of the environments of FIGS. 9A-9E. FIGS. 9A-9E illustrate several embodiments that use a network switch between a secure compute node and a storage system 904, which may be preferred because this aids scale-out and maintainability. While a secure compute node, e.g., a DPU, may be deployed as part of a storage system server (e.g., as an add-in adapter card) this reduces scale-out potential. FIGS. 9A-9E illustrate possible embodiments of secure compute nodes and their attachment to the storage system. Note, point-to-point connections may be used between secure compute node and storage system if cost reduction is needed. Note also that the compute node may be deployed as a network attached accelerator, in some approaches. These environments enable separation of near-data compute from a security domain of a storage system in order to ensure limited proliferation of cryptographic keys and thus, to reduce available cyber-attack surface.

Referring first to FIG. 9A, the environment 900 includes a network 902 that may communicate with a client site (not shown). In the environment 900, the secure compute node is a network attached accelerator 906, e.g., a DPU, that is connected (via Ethernet) to the storage system via a 200 GbE switch 908.

Referring next to FIG. 9B, the environment 910 includes a network 902 that may communicate with a client site (not shown). In the environment 910, the secure compute node is a network attached secure virtual machine 912, e.g., a virtual CPU, with an attached accelerator 914, that is connected (via IP/GbE) to the storage system via a 200 GbE switch 908.

Referring next to FIG. 9C, the environment 920 includes a network 902 that may communicate with a client site (not shown). In the environment 920, the secure compute node uses a network attached accelerator 906, e.g., a DPU, that is connected (via Remote Direct Memory Access) to the storage system via an InfiniBand switch 922. In some approaches, the DPU is used to provide a secure and isolated execution environment and/or gateway to a near-storage secure compute node.

Referring next to FIG. 9D, the environment 930 includes a network 902 that may communicate with a client site (not shown). In the environment 900, the secure compute node is a PCIe attached accelerator 932, that is connected via a PCIe bus 934 to the storage system.

Finally, referring to FIG. 9E, the environment 940 includes a network 902 that may communicate with a client site (not shown). In the environment 940, the secure compute node is a Compute Express Link (CXL) attached accelerator 942, that is connected (via PCIe/CXL) to the storage system via a CXL switch 944.

A secondary use-case of some approaches described herein, is to allow near-storage function (e.g., lambdas) deployment in the context of cloud services. The techniques and environment infrastructure described herein allows an untrusted client site to deploy near-storage operations without access to the keys that have been securely deployed prior to the secure compute node/enclave. In this scenario the client site manages access and “capabilities” of the enclaves without directly participating in operation deployment and resulting retrieval.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method (CIM), the CIM comprising:
causing a first compute function to be performed on a first secure compute node that is configured to retrieve data from a storage system, wherein
performing the first compute function includes:
retrieving encrypted first data from the storage system,
causing a first encryption key to be used to decrypt at least some of the encrypted first data, and
running predetermined code on the decrypted data; and
providing a first client site with first data that includes results of running the predetermined code on the decrypted data.

2. The CIM of claim 1, wherein the storage system does not have access to the first encryption key, wherein the first encryption key is provided to the first secure compute node by the first client site.

3. The CIM of claim 2, wherein the first secure compute node is a data processing unit (DPU) that is a secure and isolated execution environment that is connected to the storage system via an Ethernet cord or a peripheral component interconnect (PCI) express.

4. The CIM of claim 2, wherein the first secure compute node is a virtual machine that is configured to retrieve data from the storage system via an Ethernet switch, wherein the first secure compute node is attached to an accelerator component that the first secure compute node uses to perform predetermined operator functions including the decrypting of the at least some of the encrypted first data.

5. The CIM of claim 2, wherein the first secure compute node is configured according to a predetermined time-multiplexed scheme, wherein the predetermined time-multiplexed scheme configuration is based on: the first secure compute node holding encryption key(s) for a predetermined amount of time; and the first secure compute node wiping a history of execution of compute functions on the first secure compute node in response to a determination that the predetermined amount of time has passed, wherein the wiping includes: verifiably deleting the encryption key(s); uploading results of the performance of compute functions to the storage system; and verifiably deleting the results of the performance of compute functions.

6. The CIM of claim 5, comprising: receiving, subsequent to the predetermined amount of time passing, on the first secure compute node from a second client site, a second encryption key; and causing a second compute function to be performed on the first secure compute node for the second client site, wherein the storage system does not have access to the second encryption key.

7. The CIM of claim 2, comprising: causing a second compute function to be performed on a second secure compute node that is configured to retrieve data from the storage system, wherein the first compute function and the second compute function are concurrently performed; and providing a second client site with second data that results from performing the second compute function.

8. The CIM of claim 2, comprising: receiving, from the first client site, the predetermined code with a request to perform the first compute function, wherein a sum size of the predetermined code and the results of the predetermined code on the decrypted data is relatively smaller than a size of the encrypted first data retrieved from the storage system.

9. The CIM of claim 2, wherein a portion of the encrypted first data is not decrypted during performance of the first compute function, wherein performance of the first compute function includes: deleting the portion of the encrypted first data or adding the portion of the encrypted first data into the first data provided to the first client site.

10. A computer program product (CPP), the CPP comprising:
a set of one or more computer-readable storage media; and
program instructions, collectively stored in the set of one or more storage media, for causing a processor set to perform the following computer operations:
cause a first compute function to be performed on a first secure compute node that is configured to retrieve data from a storage system, wherein performing the first compute function includes:
retrieving encrypted first data from the storage system,
causing a first encryption key to be used to decrypt at least some of the encrypted first data, and
running predetermined code on the decrypted data; and
provide a first client site with first data that includes results of running the predetermined code on the decrypted data.

11. The CPP of claim 10, wherein the storage system does not have access to the first encryption key, wherein the first encryption key is provided to the first secure compute node by the first client site.

12. The CPP of claim 11, wherein the first secure compute node is a data processing unit (DPU) that is a secure and isolated execution environment that is connected to the storage system via an Ethernet cord or a peripheral component interconnect (PCI) express.

13. The CPP of claim 11, wherein the first secure compute node is a virtual machine that is configured to retrieve data from the storage system via an Ethernet switch, wherein the first secure compute node is attached to an accelerator component that the first secure compute node uses to perform predetermined operator functions including the decrypting of the at least some of the encrypted first data.

14. The CPP of claim 11, wherein the first secure compute node is configured according to a predetermined time-multiplexed scheme, wherein the predetermined time-multiplexed scheme configuration is based on: the first secure compute node holding encryption key(s) for a predetermined amount of time; and the first secure compute node wiping a history of execution of compute functions on the first secure compute node in response to a determination that the predetermined amount of time has passed, wherein the wiping includes: verifiably deleting the encryption key(s); uploading results of the performance of compute functions to the storage system; and verifiably deleting the results of the performance of compute functions.

15. The CPP of claim 14, the CPP comprising: program instructions, collectively stored in the set of one or more storage media, for causing the processor set to perform the following computer operations: receive, subsequent to the predetermined amount of time passing, on the first secure compute node from a second client site, a second encryption key; and cause a second compute function to be performed on the first secure compute node for the second client site, wherein the storage system does not have access to the second encryption key.

16. The CPP of claim 11, the CPP comprising: program instructions, collectively stored in the set of one or more storage media, for causing the processor set to perform the following computer operations: cause a second compute function to be performed on a second secure compute node that is configured to retrieve data from the storage system, wherein the first compute function and the second compute function are concurrently performed; and provide a second client site with second data that results from performing the second compute function.

17. The CPP of claim 11, the CPP comprising: program instructions, collectively stored in the set of one or more storage media, for causing the processor set to perform the following computer operations: receive, from the first client site, the predetermined code with a request for performing the first compute function, wherein a sum size of the predetermined code and the results of the predetermined code on the decrypted data is relatively smaller than a size of the encrypted first data retrieved from the storage system.

18. The CPP of claim 11, wherein a portion of the encrypted first data is not decrypted during performance of the first compute function, wherein performance of the first compute function includes: deleting the portion of the encrypted first data or adding the portion of the encrypted first data into the first data provided to the first client site.

19. A computer system (CS), the CS comprising:
a processor set;
a set of one or more computer-readable storage media;
program instructions, collectively stored in the set of one or more storage media, for causing the processor set to perform the following computer operations:
cause a first compute function to be performed on a first secure compute node that is configured to retrieve data from a storage system, wherein performing the first compute function includes:
retrieving encrypted first data from the storage system,
causing a first encryption key to be used to decrypt at least some of the encrypted first data, and
running predetermined code on the decrypted data; and
provide a first client site with first data that includes results of running the predetermined code on the decrypted data.

20. The CS of claim 19, wherein the storage system does not have access to the first encryption key, wherein the first encryption key is provided to the first secure compute node by the first client site.
